(19) United States
(12) Patent Application Publication
(10) Pub. No.: US 2025/0335842 A1
(43) Pub. Date: Oct. 30, 2025

(54) LIQUIDITY MODELING

(71) Applicant: Wells Fargo Bank, N.A., San Francisco, CA (US)

(72) Inventors: Chandrabhan Kushwaha, Bangalore (IN); Sivakumar M, Bangalore (IN); Govinda Rajulu Nelluri, Hyderabad (IN); Vijaya kumar Rasala, Hyderabad (IN)

(21) Appl. No.: 18/648,702

(22) Filed: Apr. 29, 2024

(51) Int. Cl. G06Q 10/0631

(52) U.S. Cl. CPC G06Q 10/06313

(57) ABSTRACT

An example computer system for liquidity modeling can include: one or more processors; and non-transitory computer-readable storage media encoding instructions which, when executed by the one or more processors, causes the computer system to: receive requests from an organization to conduct one or more transactions, where the transactions include receivable transactions and payable transactions; identify a current liquidity status and one or more business activities associated with the organization; predict a liquidity requirement of the organization based upon the receivable transactions, the payable transactions, the current liquidity status and the one or more business activities; and prioritize the one or more transactions based upon the liquidity requirement.

### BACKGROUND

Effective cash flow management is essential for managing account payables and receivables promptly and accurately. Organizations may conduct various debit and credit transactions in day-to-day business. Depending on the timing of these transactions, the organizations may not have a positive liquidity balance to fulfill their daily liquidity needs or debts. Further, it may be difficult for these organizations to predict their required liquidity requirements for a particular day.

### SUMMARY

Examples provided herein are directed to liquidity modeling.

According to one aspect, an example computer system for liquidity modeling can include: one or more processors; and non-transitory computer-readable storage media encoding instructions which, when executed by the one or more processors, causes the computer system to: receive requests from an organization to conduct one or more transactions, where the transactions include receivable transactions and payable transactions; identify a current liquidity status and one or more business activities associated with the organization; predict a liquidity requirement of the organization based upon the receivable transactions, the payable transactions, the current liquidity status and the one or more business activities; and prioritize the one or more transactions based upon the liquidity requirement.

According to another aspect, an example method for liquidity modeling can include: receiving requests from an organization to conduct one or more transactions, where the transactions include receivable transactions and payable transactions; identifying a current liquidity status and one or more business activities associated with the organization; predicting a liquidity requirement of the organization based upon the receivable transactions, the payable transactions, the current liquidity status and the one or more business activities; and prioritizing the one or more transactions based upon the liquidity requirement.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for liquidity modeling.

FIG. 2 shows example logical components of a server device of the system of FIG. 1.

FIG. 3 shows an example method as executed by the system of FIG. 1.

FIG. 4 shows example physical components of the server device of FIG. 2.

### DETAILED DESCRIPTION

This disclosure relates to liquidity modeling.

Examples provided herein can be used to predict a liquidity requirement of an organization and prioritize one or more receivable transactions over payable transactions of the organization based upon the predicted liquidity requirement and correlation between transactions of multiple customers.

There can be various advantages associated with the technology described herein. For instance, the technology can be used to predict a liquidity requirement of an organization on a particular day by analyzing a current liquidity status, pending payable transactions, the organization's business activities, macroeconomic conditions, and the like. In addition, the technology can be used to determine a correlation of one or more transactions (receivables and payables) associated with the organization. Further, it can be used to prioritize one or more receivable transactions over the payable transactions and automatically delay or speed up the payable transactions associated with the organization based on the predicted liquidity requirement of each customer and the determined correlation.

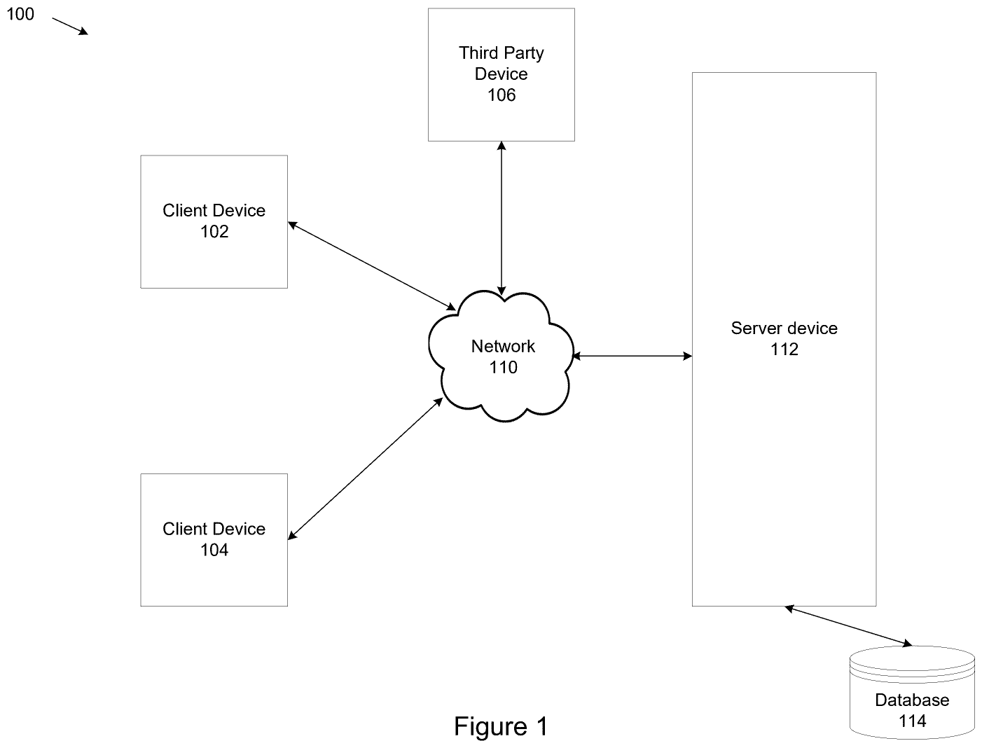

FIG. 1 schematically shows aspects of one example system 100 programmed to provide liquidity modeling. In this example, the system 100 can be a computing environment that includes a plurality of client and server devices. The example system 100 includes client devices 102, 104, a third party device 106, a server device 112, and a database 114. The client devices 102, 104 and the third party device 106 can communicate with the server device 112 through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client devices 102, 104 and the third party device 106 can be programmed to communicate with the server device 112 to conduct financial transactions, as described herein. Many other configurations are possible.

The example client device 102 is programmed to conduct financial transactions with one or more other parties. In one example, the client device 102 communicates with the server device 112 to make and receive payments. For instance, in one example, a first organization uses the client device 102 to communicate with the server device 112 to make a payment to a second organization associated with the client device 104.

The example client device 104 is programmed to conduct financial transactions with one or more other parties. In one example, the client device 104 communicates with the server device 112 to make and receive payments. For instance, in one example, the client device 104 communicates with the server device 112 to receive a payment from the first organization associated with the client device 102.

The example third party device 106 is programmed to provide information from outside of the system 100. In some examples, this information can be financial information associated with one or more of the first and second organizations and/or industries associated therewith. More specifically, this can include information associated with the banking activities of the first and second organizations, macro trends associated with the industries associated with the first and second organizations, etc.

For instance, in one example, the third party device 106 is another financial institution that provides banking information about one or both of the first and second organizations associates with the client devices 102, 104, such as account balance or credit information. In another example, the third party device 106 provides information associated with the trends of an industry relevant to the organizations associates with the client devices 102, 104, such as a credit crunch in an industry like the automotive industry. Many other examples are possible.

The example server device 112 is programmed to provide financial services for one or more of the first and second organizations associated with the client devices 102, 104. For instance, as noted, the server device 112 is programmed to provide payment services as the first and second organizations associated with the client devices 102, 104 make and receive payments.

The example database 114 is programmed to store transactional information and associated modeling information for the financial institution associated with the server device 112. In one example, the database 114 is divided into a payables corpus and a receivables corpus. As provided further below, the payables corpus and the receivables corpus are programmed to store and order payables and receivables data. Further, the database 114 is programmed to store modeling information associated therewith to allow the server device 112 to provide liquidity modeling, as described further below.

The network 110 provides a wired and/or wireless connection between the client devices 102, 104, the third party device 106, and the server device 112. In some examples, the network 110 can be a local area network, a wide area network, the Internet, or a mixture thereof. Many different communication protocols can be used. Although only three devices are shown, the system 100 can accommodate hundreds, thousands, or more of computing devices.

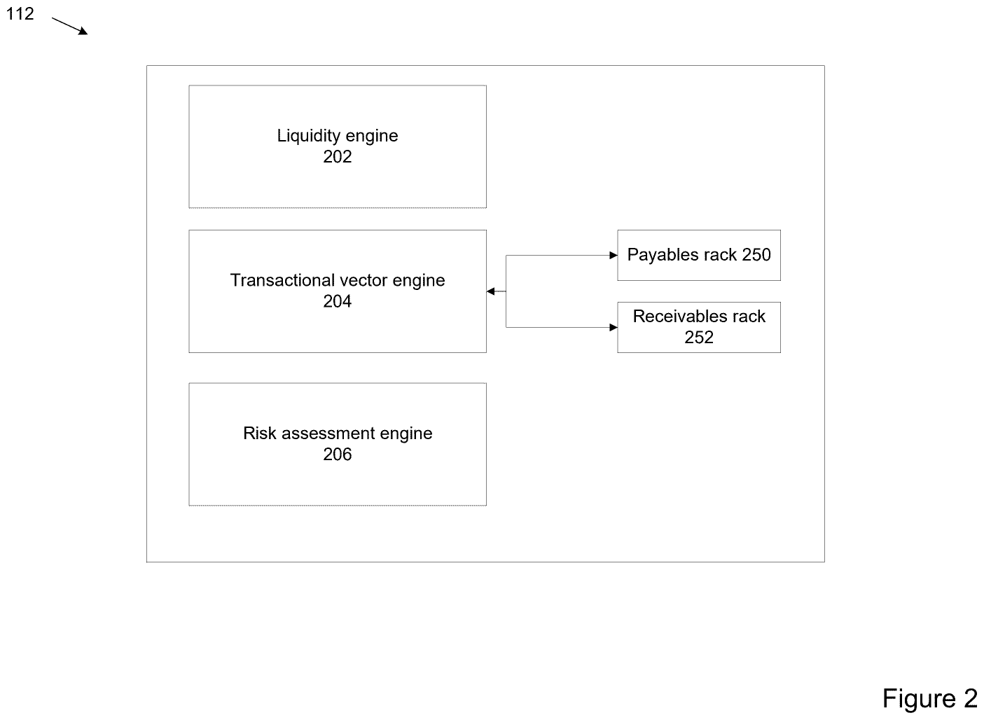

Referring now to FIG. 2, additional details of the server device 112 are shown. In this example, the server device 112 has various logical modules that assist in liquidity modeling. The server device 112 can, in this instance, include a liquidity engine 202, a transactional vector engine 204, and a risk assessment engine 206. In other examples, more or fewer engines providing the same or different functionality can be used.

In this example, the liquidity engine 202 is programmed to receive transaction information about the organizations associated with the devices 102, 104 and provide liquidity modeling. In generally, liquidity modeling looks at various factors, such as payment and receivables information, internal risk information, and external risk information, to provide a predictive model of liquidity that allows the organizations to make and receive payments in an ordered and efficient manner.

For instance, the liquidity engine 202 receives payable and receivable information for the first organization associated with the client device 102. This first organization is a customer of the financial institution associated with the server device 112. The liquidity engine 202 stores this payable and receivable information for the first organization in the database 114 and uses that information to model the liquidity needs for the first organization. In this example, the liquidity engine 202 communicates with the transactional vector engine 204 and/or the risk assessment engine 206 to do so.

The example transactional vector engine 204 is programmed to provide modeling for the transactional information received by the liquidity engine 202. For instance, in one example, the transactional vector engine 204 orders the payables and receivables for the first organization to address liquidity needs.

In this example, the transactional vector engine 204 creates two racks for the first organization, a payables rack 250 and a receivables rack 252. The two racks 250, 252 form vectors that are stored within the payables corpus and the receivables corpus of the database 114. As the first organization makes and receives payments using the client device 102, the transactional vector engine 204 constantly updates the payables rack 250 and the receivables rack 252 to provide the desired liquidity. More specifically, the transactional vector engine 204 orders the payables and receivables on the racks 250, 252 to provide the desired effects.

For instance, the transactional vector engine 204 orders payments on the payables rack 250 to coincide with receivables on the receivables rack 252 to provide the desired liquidity. This prioritization can include the batching of transactions to accomplish the desired liquidity. This batching of transactions can result in the delay or quickening of one or more of the transactions.

In one example, assume the following is the current state of the payables rack 250 and the receivables rack 252 for the first organization.

| Payables rack 250 | Receivables rack 252 |
|---|---|
| $5,000 | $500 |
| $1,000 | $6,000 |
| $10,000 | $15,000 |

In the example above, the transactional vector engine 204 can use the payables rack 250 and the receivables rack 252 to model the liquidity requirements for the first organization. Assume the first organization starts with a balance of $3,000. In this example, the first organization would not have sufficient funds to make the $5,000 payment to the second organization. However, the transactional vector engine 204 can model and manipulate the payables and receivables as follows to provide the needed liquidity.

| Payables rack 250 | Receivables rack 252 |
|---|---|
| $1,000 | $6,000 |
| $5,000 | $500 |
| $10,000 | $15,000 |

The reordering of the payables rack 250 and the receivables rack 252 thereby allows the first organization to receive the $6,000 in sufficient time (thereby increasing the account balance to $9,000) to make the $5,000 payment. The transactional vector engine 204 can constantly reorder the vectors associated with the payables rack 250 and the receivables rack 252 to provide this desired liquidity.

In some examples, the transactional vector engine 204 can further manipulate the payables rack 250 and the receivables rack 252 based upon an importance of a particular transaction. For instance, when one payable transaction on the payables rack 250 is a near real-time transaction (such as a wire transaction), while another payable transaction on the payables rack 250 is a non-near real-time transaction (such as a check transaction), the transactional vector engine 204 can order the payables rack 250 to prioritize the near real-time transaction.

As illustrated, the top rows of the payables rack 250 and the receivables rack 252 as defined by the transactional vector engine 204 are the most important, as these rows will be executed before other rows. These top rows can therefore define a hyperplane where the most important transactions are executed. This hyperplane can be manipulated as needed by the transactional vector engine 204 to provide the desired liquidity. Many other configurations are possible.

In this example, the risk assessment engine 206 is programmed to mitigate risks associated with the payments and receivables for the first organization, the second organization, and/or the financial institution. For instance, the risk assessment engine 206 is programmed to consider both internal and external information associated with the first organization and communicate with the transactional vector engine 204 to reorder the payables rack 250 and the receivables rack 252 to mitigate risk.

For example, the risk assessment engine 206 can be programmed to access internal information about the first organization, such as payment and/or balance histories and/or credit risk. In one example, the risk assessment engine 206 can determine that the first organization is in a cyclical business that historically is slow for a certain portion of the year. With this knowledge, the risk assessment engine 206 can be programmed to allow for these cyclical changes while maximizing the liquidity requirements for the first organization.

Similarly, the risk assessment engine 206 can be programmed to received information outside the system 100 to assess liquidity risk. In one example, the risk assessment engine 206 receives transactional data from the third party device 106 that may be relevant to the first organization. This transactional data can be, for instance, tokenized. This tokenized transactional data can follow a predefined format that provides information about transactions, including transaction amounts, parties, dates, etc. The tokenized transactional data is consumed by the risk assessment engine 206 to provide great mitigation of risk.

For instance, assume that the first organization also has accounts at other financial institutions. Information about those accounts, such as balance information, could be shared by the third party device 106 with the risk assessment engine 206. The risk assessment engine 206 can then use this balance information to increase liquidity or decrease liquidity for the first organization. For instance, if the balances are significant and stable, the risk assessment engine 206 can communicate with the transactional vector engine 204 to increase the liquidity of the first organization. Conversely, if the balances are low or unstable, the risk assessment engine 206 can communicate with the transactional vector engine 204 to lower the liquidity provided by the system 100, thereby mitigating possible risks to the financial institution.

Further, the risk assessment engine 206 can receive other information from the third party device 106, such as macro trends. Such macro trends can include macroeconomic conditions like inflation rate prediction, dollar value, consumer price index, economic growth/crisis, and other external parameters such as the pandemic, emergency situations in the customer's location/business, and the like

For instance, assume that the first organization is an insurance company, and the macro trends are showing a trend for higher claims due to increased forest fire activity. Depending on the identified risk factors, the risk assessment engine 206 can communicate with the transactional vector engine 204 to prioritize payables to increase liquidity for the insurance company to make claim payments and/or prioritize receivables to decrease liquidity if there is a risk the insurance company will not be able to cover its obligations.

Similarly, the risk assessment engine 206 can receive other business information about the first organization. For instance, the first organization may be in an industry with common bankruptcies, and it may become more likely that the first organization may declare bankruptcy. In such as example, the risk assessment engine 206 can communicate with the transactional vector engine 204 to prioritize receivables to minimize risks to the financial institution.

Similarly, the business information can include other information about the first organization, such as business activities like the purchase of raw materials, deployment/delivery of products, production and sales scheduled, investing and financing, and other business-related activities. These business activities can be used to prioritize the racks 250, 252 as provided herein. Many other configurations are possible.

While the examples above are provided with respect to the first organization associated with the client device 102, the server device 112 is programmed to provide enhanced liquidity across multiple organizations, such as other customers of the financial institution associated with the server device 112. For instance, the liquidity engine 202, the transactional vector engine 204, and the risk assessment engine 206 can be programmed to manipulate the payable racks and receivable racks of multiple customers of the financial institution to maximize liquidity while mitigating risks for the financial institution.

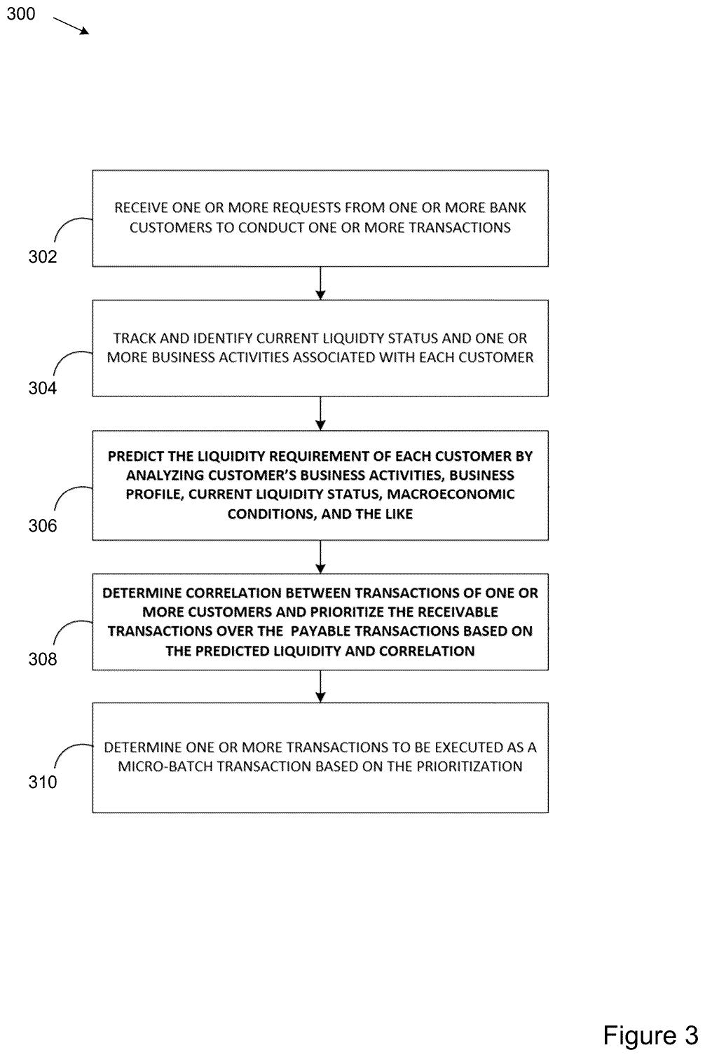

Referring now to FIG. 3, an example method 300 for modeling liquidity as executed by the system 100 is shown. In this example, various customers of the financial institution conduct transactions as the financial institution uses the liquidity modeling described herein.

At operation 302 of the method 300, the system 100 receives one or more transaction requests from one or more financial institution customers to conduct the transactions. As noted, the financial institution customers may be business individuals, corporate customers, or business organizations that have one or more savings accounts/current accounts with the financial institution. For instance, the business customers may initiate one or more transaction requests via an online financial institution portal or a mobile financial institution application. The one or more transactions may include receivable transactions, payable transactions, and the like associated with the business customers.

At operation 304, the system 100 tracks and identifies the current liquidity status and one or more business activities associated with each customer. The current liquidity status may include the funds and working capital available to the business customer on a particular day.

At operation 306, the system 100 predicts the liquidity requirement associated with each business customer. The system 100 analyzes one or more identified business activities of the customer, the current liquidity status associated with the customer, the business profile, pending payable transactions, the history of the business activities conducted by the customer, macroeconomic conditions, and the like.

At operation 308, the system 100 determines the correlation between the requested transactions associated with one or more customers. For instance, the system 100 analyzes the receivable and payable transaction requests of one or more customers and determines the correlation among the transactions of various customers. The system 100 determines how much liquidity each customer may need and correlates the transaction requests of one or more customers to meet the liquidity requirement of each customer. The system 100 further prioritizes one or more receivable transactions over the payable transactions and automatically delays the payable transactions based on the predicted liquidity requirement associated with each customer and the determined correlation between the transactions.

At operation 310, the system 100 determines one or more transactions to be executed as a micro-batch transaction based on prioritization. The system 100 links the ledgers associated with the transactions of the business customers and creates a micro-batch transaction based on the order of prioritization of one or more transactions. All the transactions may be executed via the micro-batch transaction to meet the liquidity requirements of the business customers.

This example method 300 can have many variations, as described further above.

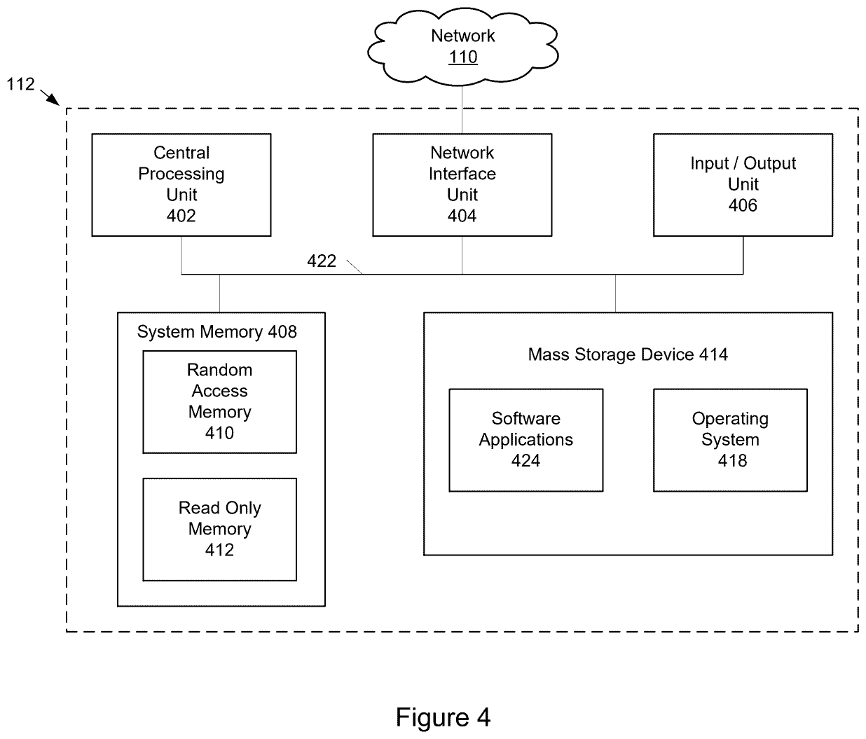

As illustrated in the embodiment of FIG. 4, the example server device 112, which provides the functionality described herein, can include at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system containing the basic routines that help transfer information between elements within the server device 112, such as during startup, is stored in the ROM 412. The server device 112 further includes a mass storage device 414. The mass storage device 414 can store software instructions and data. A central processing unit, system memory, and mass storage device similar to that shown can also be included in the other computing devices disclosed herein.

The mass storage device 414 is connected to the CPU 402 through a mass storage controller (not shown) connected to the system bus 422. The mass storage device 414 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 404 connected to the system bus 422. It should be appreciated that the network interface unit 404 may also be utilized to connect to other types of networks and remote computing systems. The server device 112 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the server device 112 can store software instructions and data. The software instructions include an operating system 418 suitable for controlling the operation of the server device 112. The mass storage device 414 and/or the RAM 410 also store software instructions and applications 424, that when executed by the CPU 402, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for liquidity modeling, comprising:
one or more processors; and
non-transitory computer-readable storage media encoding instructions which, when executed by the one or more processors, causes the computer system to:
receive requests from an organization to conduct one or more transactions, where the transactions include receivable transactions and payable transactions;
identify a current liquidity status and one or more business activities associated with the organization;
predict a liquidity requirement of the organization based upon the receivable transactions, the payable transactions, the current liquidity status and the one or more business activities; and
prioritize the one or more transactions based upon the liquidity requirement.

2. The computer system of claim 1, comprising further instructions which, when executed by the one or more processors, causes the computer system to determine a subset of the one or more transactions of to be executed as a micro-batch transaction based on prioritization.

3. The computer system of claim 1, comprising further instructions which, when executed by the one or more processors, causes the computer system to analyze the current liquidity status and pending payable transactions to prioritize the one or more transactions.

4. The computer system of claim 1, comprising further instructions which, when executed by the one or more processors, causes the computer system to analyze business activities and macroeconomic conditions to prioritize the one or more transactions.

5. The computer system of claim 1, comprising further instructions which, when executed by the one or more processors, causes the computer system to determine a correlation of receivables and payables associated with multiple organizations to prioritize the one or more transactions.

6. The computer system of claim 1, comprising further instructions which, when executed by the one or more processors, causes the computer system to delay or speed up payable transactions associated with the organization based on the liquidity requirement.

7. The computer system of claim 1, comprising further instructions which, when executed by the one or more processors, causes the computer system to:
create a payables rack, with the payables rack listing the payable transactions associated with the organization; and
create a receivables rack, with the receivables rack listing the receivable transactions associated with the organization.

8. The computer system of claim 7, comprising further instructions which, when executed by the one or more processors, causes the computer system to constantly reorder the payables rack and the receivables rack to prioritize the one or more transactions.

9. The computer system of claim 1, comprising further instructions which, when executed by the one or more processors, causes the computer system to assess internal information to mitigate risks associated with the liquidity requirement.

10. The computer system of claim 1, comprising further instructions which, when executed by the one or more processors, causes the computer system to assess external information to mitigate risks associated with the liquidity requirement.

11. A method for liquidity modeling, comprising:
receiving requests from an organization to conduct one or more transactions, where the transactions include receivable transactions and payable transactions;
identifying a current liquidity status and one or more business activities associated with the organization;
predicting a liquidity requirement of the organization based upon the receivable transactions, the payable transactions, the current liquidity status and the one or more business activities; and
prioritizing the one or more transactions based upon the liquidity requirement.

12. The method of claim 11, further comprising determining a subset of the one or more transactions of to be executed as a micro-batch transaction based on prioritization.

13. The method of claim 11, further comprising analyzing the current liquidity status and pending payable transactions to prioritize the one or more transactions.

14. The method of claim 11, further comprising analyzing business activities and macroeconomic conditions to prioritize the one or more transactions.

15. The method of claim 11, further comprising determining a correlation of receivables and payables associated with multiple organizations to prioritize the one or more transactions.

16. The method of claim 11, further comprising delaying or quickening payable transactions associated with the organization based on the liquidity requirement.

17. The method of claim 11, further comprising:
creating a payables rack, with the payables rack listing the payable transactions associated with the organization; and
creating a receivables rack, with the receivables rack listing the receivable transactions associated with the organization.

18. The method of claim 17, further comprising constantly reordering the payables rack and the receivables rack to prioritize the one or more transactions.

19. The method of claim 11, further comprising assessing internal information to mitigate risks associated with the liquidity requirement.

20. The method of claim 11, further comprising assessing external information to mitigate risks associated with the liquidity requirement.
